(19) United States
(12) Patent Application Publication
(10) Pub. No.: US 2014/0219779 A1
(43) Pub. Date: Aug. 7, 2014

(54) SUPERCHARGER

(71) Applicant: Hiroki Matsui, Toyota-shi (JP)

(72) Inventor: Hiroki Matsui, Toyota-shi (JP)

(21) Appl. No.: 13/697,559

(22) PCT Filed: Oct. 19, 2011
(86) PCT No.: PCT/JP2011/074077

§ 371 Date: Nov. 13, 2012

(51) Int. Cl. F04D 29/42; F02B 33/40

(52) U.S. Cl. CPC F04D 29/4213; F02B 33/40
USPC 415/116

(57) ABSTRACT

An inlet portion (31) of a compressor housing (30) forms part of an intake passage, and a drawing passage (35), which extends through the inlet portion (31), draws blow-by gas from outside the inlet portion (31) to inside the inlet portion (31). A throttling portion (47) is formed inside the inlet portion (31) and arranged at a joined portion of the intake passage and the drawing passage (35) so that a cross-sectional passage area at the joined portion is smaller than a cross-sectional passage area of a portion located at an intake air upstream side of the joined portion and a cross-sectional passage area of a portion located at an intake air downstream side of the joined portion.

### CROSS-REFERENCE TO RELATED APPLICATIONS

This application is a national phase application of International Application No. PCT/JP2011/074077, filed Oct. 19, 2011, the content of which is incorporated herein by reference.

### FIELD OF THE INVENTION

The present invention relates to a supercharger mounted on an internal combustion engine including a mechanism for drawing blow-by gas into an intake passage.

### BACKGROUND OF THE INVENTION

Patent document 1 describes an example of an internal combustion engine including a mechanism for drawing blow-by gas into an intake passage. As shown in FIG. 7, in the internal combustion engine, a joint 204 is arranged between a throttle valve 201 and a surge tank 202 in an intake passage 200. A downstream end 203a of a returning pipe passage 203, through which the blow-by gas flows, is connected to the joint 204.

A throttling portion 205 is formed in the joint 204 to increase the flow velocity of the intake air in the intake passage 200. The blow-by gas that flows through the returning pipe passage 203 to the downstream end 203a is efficiently drawn into the intake passage 200 by the Venturi effect.

### PRIOR ART DOCUMENT

### Patent Document

Patent Document 1: Japanese Laid-Open Patent Publication No. 2008-101472

### SUMMARY OF THE INVENTION

In the internal combustion engine described in patent document 1, the joint 204, which includes the throttling portion 205 that has a complicated shape, is added to connect the returning pipe passage 203 to the intake passage 200.

It is an object of the present invention to provide a supercharger that draws blow-by gas into an intake passage without using a joint having a complicated shape.

Means for solving the above problem and the effects of the means will now be described.

A supercharger according to the present invention includes an impeller and a compressor housing including an inlet portion configured to form part of an intake passage of an internal combustion engine. The inlet portion draws intake air toward the impeller. The compressor further includes a drawing passage, which extends through the inlet portion and draws blow-by gas from outside the inlet portion to inside the inlet portion, and a throttling portion arranged at a joined portion of the intake passage, which is formed inside the inlet portion, and the drawing passage. The throttling portion has a cross-sectional passage area at the joined portion that is smaller than a cross-sectional passage area of a portion located at an intake air upstream side of the joined portion and a cross-sectional passage area of a portion located at an intake air downstream side of the joined portion.

In the above structure, the throttling portion is arranged at the joined portion of the drawing passage and the intake passage, which is formed inside the inlet portion. This increases the flow velocity of the intake air that passes through the throttling portion from the upstream side to the downstream. Thus, the Venturi effect efficiently draws blow-by gas through the drawing passage into the intake passage.

Further, by connecting a returning passage, which draws blow-by gas into the intake passage, to a drawing passage from outside the inlet portion, a returning passage can be connected to the intake passage without adding a new joint. In other words, the compressor housing functions as the joint of the prior art. Thus, blow-by gas can be drawn to the intake passage without using a joint.

In one aspect of the present invention, a branching member is arranged inside the inlet portion. The branching member branches the intake passage into a first passage, which does not include the joined portion, and a second passage, which includes the joined portion, at the intake air upstream side of the joined portion. The first passage and the second passage are joined at the intake air downstream side of the joined portion. The throttling portion is arranged in the second passage.

In the above structure, the arrangement of the branching member inside the inlet portion branches the intake passage inside the inlet portion into the first passage and the second passage. That is, to form the first passage and the second passage, there is no need for the compressor housing to have a complicated structure.

Further, in the above structure, in the intake air that flows through the intake passage inside the inlet portion, only the intake air flowing through the second passage passes by the throttling portion. In contrast, when the intake passage in the inlet portion is not branched into a first passage and a second passage and a throttling portion is formed by decreasing a cross-sectional passage area of the entire intake passage, all of the intake air flowing through the intake passage passes by the throttling portion.

Thus, in comparison to when the intake passage in the inlet portion is not branched into a first passage and a second passage and a throttling portion is formed by decreasing a cross-sectional passage area of the entire intake passage, the above structure can reduce the flow resistance of the intake air flowing through the intake passage from the upstream side towards the downstream side. As a result, the arrangement of the throttling portion suppresses a decrease in the intake efficiency.

In one aspect of the present invention, the branching member is an annular member including an outer circumferential surface facing an inner circumferential surface of the inlet portion. The second passage includes a zone between the outer circumferential surface of the branching member and the inner circumferential surface of the inlet portion.

In the above structure, the branching member is arranged in the inlet portion so that a gap is formed between the outer circumferential surface of the annular branching member and the inner circumferential surface of the inlet portion. This branches the intake passage inside the inlet portion into the first passage and the second passage.

Preferably, the branching member is formed so that a flow rate of the intake air flowing through the first passage is greater than a flow rate of the intake air flowing through the second passage.

In the above structure, the throttling portion is formed in the second passage and not in the first passage, through which the intake air mainly flows. Thus, the arrangement of the throttling portion further suppresses a decrease in the intake efficiency.

In one aspect of the present invention, the inlet portion has an inner circumferential surface including a first inner circumferential part in which the drawing passage opens, and a second inner circumferential part located at the intake air downstream side of the first inner circumferential part. The first inner circumferential part has a larger diameter than the second inner circumferential part. The branching member is arranged in the intake passage at a portion surrounded by the first inner circumferential part.

In the above structure, the branching member is arranged inside the inlet portion at a section where the diameter is large. Thus, in comparison to when arranging the branching member at a section where the diameter is small, an increase in the flow resistance of the intake air is suppressed. Accordingly, a decrease in the flow rate of the intake air flowing through the intake passage from the upstream side to the upstream side can be suppressed.

In one aspect of the present invention, the inlet portion has an inner circumferential surface including a recess that is in communication with a downstream end of the drawing passage. The recess has a larger open area than the downstream end of the drawing passage.

In the above structure, the blow-by gas that flows to the downstream end of the drawing passage is drawn into the recess. Further, the blow-by gas in the recess is drawn into the intake passage by the Venturi effect produced when intake air passes by the throttling portion of the intake passage. The recess has a larger open area than the downstream end of the drawing passage. Thus, in comparison to when blow-by gas is drawn into the intake passage from the downstream end of the drawing passage without arranging a recess in the inner circumferential surface of the inlet portion, blow-by gas can be efficiently drawn into the intake passage.

In the present invention, when the branding member is an annular member, preferably, the inner circumferential surface of the inlet portion includes a groove that is in communication with the drawing passage and extends annularly along the inner circumferential surface, and an annular protrusion facing the groove is arranged on the outer circumference of the branching member.

In the above structure, at a portion joined with the drawing passage in the second passage, the annular protrusion arranged on the annular branching member forms the annular throttling portion. Thus, the blow-by gas in the groove is efficiently drawn into the intake passage by the Venturi effect.

Further, in one aspect of the present invention when the branching member is an annular member, the inner circumferential surface of the inlet portion includes a first inner circumferential part, in which the drawing passage opens, and a second inner circumferential part, located at the intake air downstream side of the first inner circumferential part. The first inner circumferential part has a larger diameter than the second inner circumferential part, and the branching member has the same inner diameter as the second inner circumferential part and is arranged in the intake passage at a portion surrounded by the first inner circumferential part.

In this structure, the annular branching member is arranged inside the inlet portion at a section where the diameter is large. Further, the inner diameter of the branching member is the same as the diameter of the second inner circumferential part. Further, even when the branching member is arranged inside the inlet portion, the cross-sectional passage area of the first passage is maintained to be the same as the cross-sectional passage area of the second inner circumferential part. Accordingly, an increase flow resistance of the intake air caused by the arrangement of the branching member can be suppressed.

### BRIEF DESCRIPTION OF THE DRAWINGS

FIG. 1 is a schematic diagram showing the structure of an internal combustion engine including a supercharger according to one embodiment of the present invention.

FIG. 2 is a perspective view showing a compressor housing of the supercharger.

FIG. 3 is a cross-sectional perspective view showing the internal structure of the compressor housing.

FIG. 4 is a cross-sectional side view showing the vicinity of a joined portion of the compressor housing.

FIG. 5(a) is an operation diagram showing the movement of blow-by gas that flows into a groove from a drawing passage, and FIG. 5(b) is an operation diagram showing the state of the blow-by gas drawn into an intake passage.

FIG. 6 is a cross-sectional view schematically showing a joined portion of a compressor housing in a further embodiment.

FIG. 7 is a schematic cross-sectional view showing a structure for drawing blow-by gas into an intake passage with a joint.

### DETAILED DESCRIPTION OF THE PREFERRED EMBODIMENTS

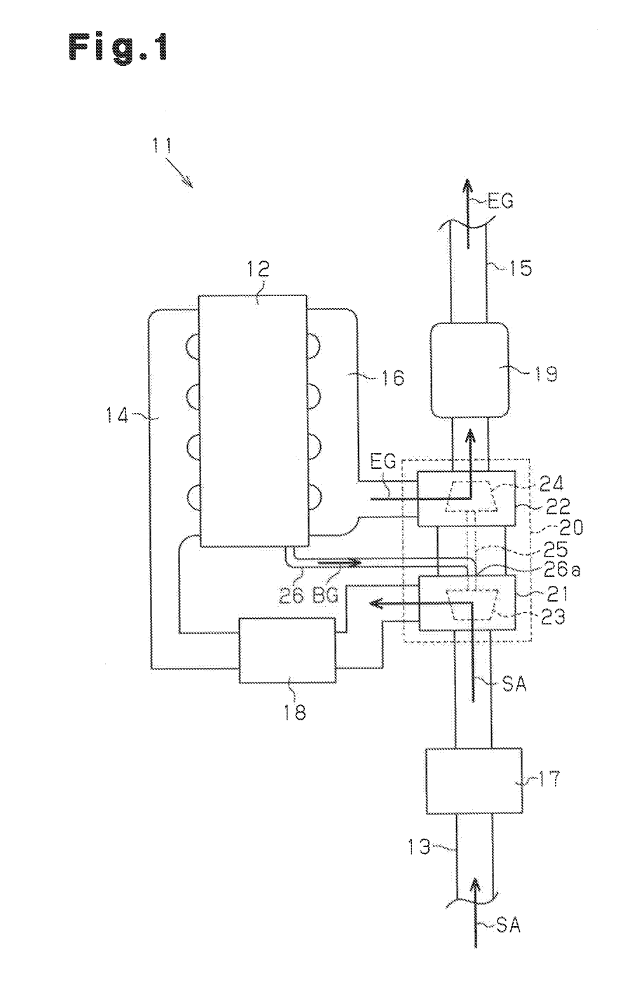

An internal combustion engine including a supercharger according to one embodiment of the present invention will now be described with reference to FIGS. 1 to 5.

As shown in FIG. 1, an internal combustion engine 11 includes an engine main body 12 connected to an intake passage 13, which draws intake air SA into combustion chambers (not shown), by an intake manifold 14. An exhaust passage 15, which discharges exhaust air EG from the combustion chambers, is also connected to the engine main body 12 by an exhaust manifold 16.

The intake passage 13 includes an air cleaner 17 to remove dirt and dust from the intake air SA that flows into an upstream end of the intake passage 13. An intercooler 18 is also arranged in the intake passage 13 at a downstream side of the air cleaner 17 to cool the air flowing through the intake passage 13. The intake air SA cooled by the intercooler 18 is drawn into the combustion chambers through the intake manifold 14.

The exhaust passage 15 includes an exhaust air purifying device 19 (or catalytic converter) to purify the exhaust air EG that flows out of the exhaust manifold 16. The exhaust air EG that flows through the exhaust air purifying device 19 is discharged from the downstream end of the exhaust passage 15.

The internal combustion engine 11 also includes a supercharger 20 that compresses the intake air SA and sends the intake air SA into the combustion chambers. The supercharger 20 includes a compressor unit 21 arranged between the air cleaner 17 and the intercooler 18 of the intake passage 13. Further, the supercharger 20 includes a turbine unit 22 arranged at an upstream of the exhaust air purifying device 19 in a flowing direction of the exhaust air EG flowing through the exhaust passage 15.

The compressor unit 21 includes a compressor impeller 23 that rotates to accelerate the intake air SA flowing through the compressor unit 21. This sends the intake air SA towards the intercooler 18. The turbine unit 22 includes a turbine impeller 24 rotated by the flow of the exhaust air EG from the exhaust manifold 16. A rotation shaft 25 couples the compressor impeller 23 and the turbine impeller 24. The flow of the exhaust air EG rotates the turbine impeller 24 thereby rotating the compressor impeller 23.

A returning pipe passage 26, which serves as a reduction passage that draws blow-by gas BG generated in the engine main body 12 into the intake passage 13, is connected to the engine main body 12 of the present embodiment. A downstream end 26a of the returning pipe passage 26 extends to the compressor unit 21.

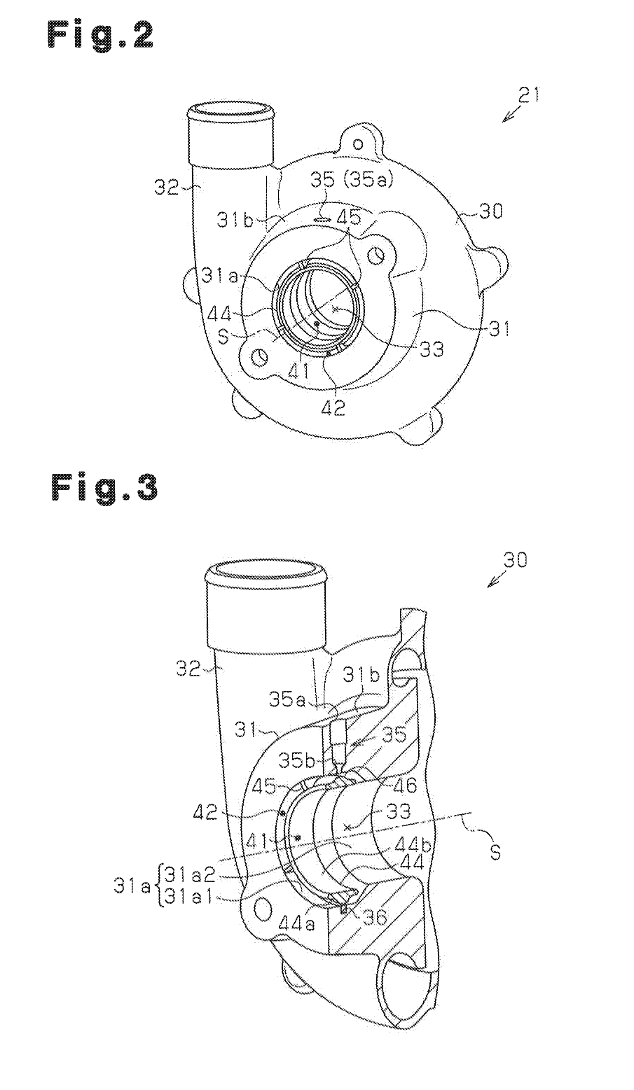

A structure of the compressor unit 21 will now be described with reference to FIG. 2 to FIG. 4.

As shown in FIGS. 2 and 3, a compressor housing 30 of the compressor unit 21 includes a substantially cylindrical inlet portion 31 having an inner circumferential surface 31a that surrounds an intermediate position of the intake passage 13. That is, the inlet portion 31 forms part of the intake passage 13. The intake air SA that flows from the upstream side into the inlet portion 31 is drawn into the compressor impeller 23. The intake air SA, which is accelerated by the rotation of the compressor impeller 23, is sent toward the intercooler 18 through an outlet portion 32 arranged to surround the compressor impeller 23. In the present embodiment, a zone surrounded by the inner circumferential surface 31a of the inlet portion 31 in the intake passage 13 may be referred to as “intake zone 33”.

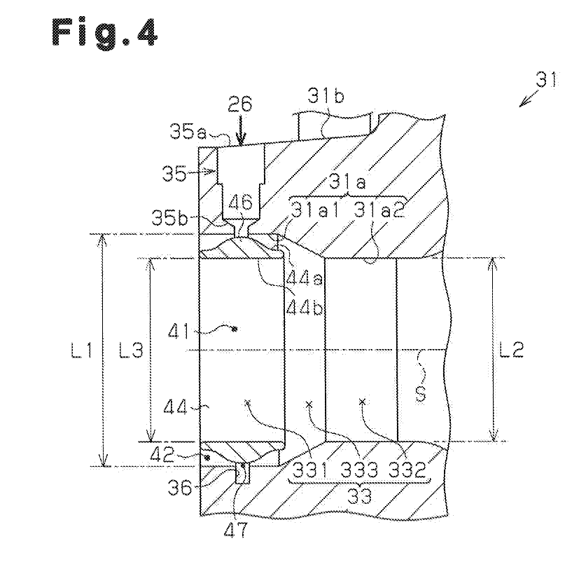

As shown in FIG. 4, a portion of the intake zone 33 located toward the upstream side in the flowing direction of the intake air SA defines a diameter enlarged portion 331 having a large cross-sectional area. A portion of the intake zone 33 located at the downstream side of the diameter enlarged portion 331 defines a non-diameter enlarged portion 332 having a smaller cross-sectional area than the diameter enlarged portion 331. Further, a portion of the intake zone 33 located between the diameter enlarged portion 331 and the non-diameter enlarged portion 332 defines a tapered portion 333 having a cross-sectional area that gradually decreases from the diameter enlarged portion 331 toward the non-diameter enlarged portion 332. Thus, in the inner circumferential surface 31a of the inlet portion 31, a first inner circumferential part 31a1 surrounding the diameter enlarged portion 331 has a diameter L1 that is larger than a diameter L2 of a second inner circumferential part 31a2 surrounding the non-diameter enlarged portion 332. That is, the diameter enlarged portion 331 has a larger diameter than the non-diameter enlarged portion 332.

The inlet portion 31 includes a drawing passage 35 that extends in a radial direction from a rotation axis S of the compressor impeller 23. The drawing passage 35 includes an upstream end 35a, which opens in an outer circumferential surface 31b of the inlet portion 31, and a downstream end 35b, which opens in the diameter enlarged portion 331 of the intake zone 33. The downstream end 26a of the returning pipe passage 26 is connected to the drawing passage 35 from the outer side of the inlet portion 31. The downstream end 35b of the drawing passage 35 narrows inward in the radial direction.

The downstream end 35b of the drawing passage 35 is opens in a groove 36, which serves as an annular recess formed in the first inner circumferential part 31a1. The groove 36 is annular and extends around the rotation axis S of the compressor impeller 23. The groove 36 has a width (length in the sideward direction as viewed in FIG. 4) that is about the same as that of the downstream end 35b of the drawing passage 35. However, an open area of the groove 36 is larger than an open area of the downstream end 35b of the drawing passage 35.

As shown in FIGS. 3 and 4, a spacer 44 is arranged in the inlet portion 31 of the present embodiment serving as a branching member that branches the intake zone 33 into a first passage 41, which does not include a portion joined with the drawing passage 35, and a second passage 42, which includes the joined portion. As shown in FIG. 4, the spacer 44, which is arranged in the diameter enlarged portion 331, includes an outer circumferential surface 44a facing the first inner circumferential part 31a1. Further, the spacer 44 includes an inner circumferential surface 44b having a diameter L3 that is the same as the diameter L2 of the second inner circumferential part 31a2.

The outer circumferential surface 44a of the spacer 44 includes a plurality of (four in FIG. 2) projections 45 projecting outward in the radial direction. The projections 45 are arranged at substantially equal intervals in the circumferential direction. The spacer 44 is fitted into the inlet portion 31 such that a distal end (radially outward end) of each projection 45 comes into contact with the first inner circumferential part 31a1. The center of the inner circumferential surface 44b of the spacer 44 substantially coincides with the center of the first inner circumferential part 31a1 and the center of the second inner circumferential part 31a2.

The first passage 41 is formed at the inner circumferential side of the spacer 44. The second passage 42 is formed between the outer circumferential surface 44a of the spacer 44 and the first inner circumferential part 31a1. The second passage 42 is branched from the first passage 41 at the intake air upstream side of the portion joined with the drawing passage 35 and joins the first passage 41 at the intake air downstream side of the joined portion.

As shown in FIG. 4, a middle part in the widthwise direction (sideward direction as viewed in FIG. 4) of the spacer 44 faces the groove 36 in the first inner circumferential part 31a1. An annular protrusion 46 is formed at a portion facing the groove 36 on the outer circumferential surface 44a of the spacer 44. The protrusion 46 of the present embodiment gradually becomes thicker from the intake air upstream side towards the portion joined with the drawing passage 35 in the second passage 42. The protrusion 46 gradually becomes thinner from the joined portion towards the intake air downstream side. The arrangement of the protrusion 46 on the outer circumference of the spacer 44 forms a throttling portion 47 that decreases a cross-sectional passage area at the joined portion from a cross-sectional passage area of portions located at the intake air upstream side and intake air downstream side of the portion joined with the drawing passage 35 in the second passage 42.

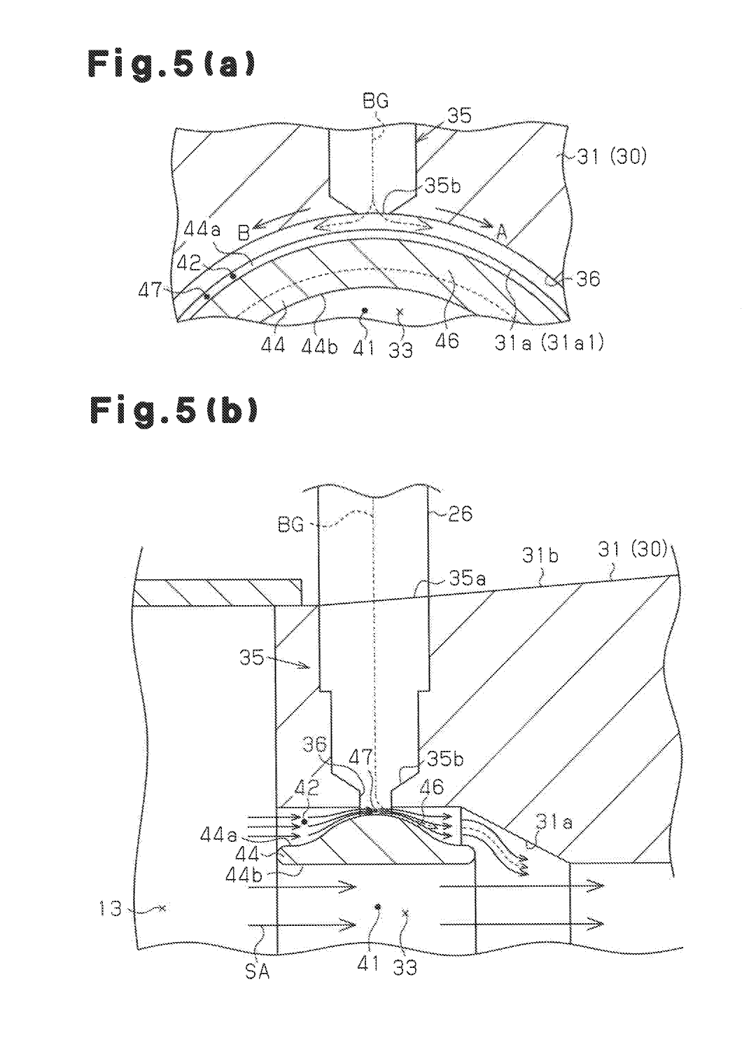

The operation when the blow-by gas BG generated in the engine main body 12 is drawn into the intake passage 13 will now be described with reference to FIGS. 5(a) and 5(b).

When the engine main body 12 is driven, the blow-by gas BG flows through the returning pipe passage 26 towards the compressor housing 30. In this case, when the supercharger 20 is driven, the rotation of the compressor impeller 23 produces suction force that acts in the returning pipe passage 26, which is in communication with the intake passage 13 through the drawing passage 35. As a result, the flow velocity of the blow-by gas BG in the returning pipe passage 26 when the supercharger 20 is driven becomes faster than the flow velocity of the blow-by gas BG in the returning pipe passage 26 when the supercharger 20 is not driven. The blow-by gas BG that flows into the drawing passage 35 from the returning pipe passage 26 is thus drawn into the groove 36 from the downstream end 35b of the drawing passage 35.

The groove 36 of the present embodiment is annular. As shown in FIG. 5(a), some of the blow-by gas BG that flows into the groove 36 from the drawing passage 35 flows through the groove 36 in a first direction A (clockwise direction as viewed in FIG. 5(a)) and the remaining blow-by gas BG flows through the groove 36 in a second direction B (counterclockwise direction as viewed in FIG. 5(a)). As a result, the blow-by gas BG is evenly spread throughout the entire groove 36.

A foreign matter that inhibits the flow of the blow-by gas BG may be present in the first direction A of the opening of the drawing passage 35 in the groove 36. The “foreign matter” referred to herein may be a deposit of the oil contained in the blow-by BG. In the groove 36 that includes such a foreign matter, the flow of the blow-by gas BG in the first direction A from the opening is restricted by the foreign matter, and the flow of the blow-by BG in the second direction B from the opening portion is permitted. Thus, even if the foreign matter is present at only one location in the groove 36, the blow-by gas BG is spread substantially evenly over the entire groove 36.

When the supercharger 20 is driven, the intake air SA strongly flows through the intake passage 13 towards the engine main body 12. When entering the inlet portion 31 of the compressor housing 30, such flow of the intake air SA is divided into the first passage 41 and the second passage 42. As the intake air SA flows through the second passage 42 from the upstream side towards the downstream side, the blow-by gas BG in the groove 36 is drawn into the second passage 42. Further, in the present embodiment, the throttling portion 47 is formed in the portion joined with the drawing passage 35 in the second passage 42, as shown in FIG. 5(b). Thus, in the second passage 42, the flow velocity of the intake air SA in the vicinity of the groove 36 becomes faster than when the throttling portion 47 is not arranged. As a result, the blow-by gas BG in the groove 36 is efficiently drawn into the second passage 42 by the Venturi effect. The intake air SA flowing through the first passage 41 from the upstream towards the downstream does not pass by the throttling portion 47.

The intake air SA containing the blow-by gas BG is flows to the downstream side of the second passage 42 and is then joined with the intake air SA that flows through the first passage 41 and then flows to the downstream side of the compressor housing 30 through the outlet portion 32. The intake air SA containing the blow-by gas BG is then cooled by the intercooler 18 and drawn into the combustion chambers of the engine main body 12 through the intake manifold 14.

As described above, the present embodiment has the advantages described below.

(1) The returning pipe passage 26 is connected to the drawing passage 35 from the outer side of the inlet portion 31 of the compressor housing 30. That is, the returning pipe passage 26 is connected to the intake passage 13 without newly adding a dedicated member (joint 204 in FIG. 7) that connects the returning pipe passage 26 to the intake passage 13. The blow-by gas BG is thus drawn into the intake passage 13 without using the joint 204 that has a complicated structure.

(2) The throttling portion 47 is arranged at the joined portion of the drawing passage 35, which is connected to the returning pipe passage 26, and the intake passage 13. In comparison to when the throttling portion 47 is not arranged in the intake passage 13 at the portion joined with the drawing passage 35, the arrangement of the throttling portion 47 produces the Venturi effect and draws the blow-by gas BG more efficiently into the intake passage 13.

(3) The drawing passage 35, which is connected to the returning pipe passage 26, is arranged at the inlet portion 31 of the compressor housing 30. The inlet portion 31 is located near the compressor impeller 23, which is the generation source of negative pressure during rotation. Thus, in comparison to when the returning pipe passage 26 is connected to the upstream side of the compressor housing 30 in the intake passage 13, the suction force produced by the rotation of the compressor impeller 23 is used more effectively since the returning pipe passage 26 is connected near the generation source of the negative pressure. As a result, in comparison to when the returning pipe passage 26 is connected to the upstream side of the compressor housing 30 in the intake passage 13, the blow-by gas BG is drawn into the intake passage 13 more efficiently.

(4) In the present embodiment, the arrangement of the spacer 44 in the inlet portion 31 branches the intake passage 13 into the first passage 41 and the second passage 42 in the inlet portion 31. Thus, the first passage 41 and the second passage 42 can be formed without complicating the shape of the compressor housing 30.

(5) In the intake air SA that enters the inlet portion 31, the intake air SA that flows through the first passage 41 does not pass by the throttling portion 47, and only the intake air SA that flows through the second passage 42 passes through the throttling portion 47. In contrast, when a throttling portion is formed by narrowing the cross-sectional passage area of the entire intake passage 13 without branching the intake passage 13 into the first passage 41 and the second passage 42 at the inlet portion 31, all of the intake air SA flowing through the intake passage 13 passes through the throttling portion. Thus, in the present embodiment, the flow resistance of the intake air SA flowing through the intake passage 13 from the upstream side towards the downstream side can be reduced compared to when the throttling portion is formed by narrowing the cross-sectional passage area of the entire intake passage 13 without branching the intake passage 13 into the first passage 41 and the second passage 42 at the inlet portion 31. As a result, a decrease in the suction efficiency caused by the arrangement of the throttling portion 47 is further suppressed.

(6) The throttling portion 47 is formed in the second passage 42 and not in the first passage 41, through which the intake air SA mainly flows. As a result, a decrease in the intake efficiency caused by the arrangement of the throttling portion 47 is further suppressed.

(7) The spacer 44 is arranged at the diameter enlarged portion 331. Thus, in comparison to when the spacer 44 is arranged at the non-diameter enlarged portion 332, an increase in the flowing resistance with respect to the intake air SA caused by the arrangement of the spacer 44 in the inlet portion 31 is suppressed. Accordingly, a decrease in the flow rate of the intake air SA flowing through the intake passage 13 from the upstream side towards the downstream side can be suppressed.

(8) When the compressor impeller 23 is rotating, a force that moves the spacer 44 to the intake air downstream side is applied to the spacer 44. However, even when the spacer 44 is forced to move toward the intake air downstream side, the projection 45 of the spacer 44 comes into contact with the portion surrounding the tapered portion 333 in the inner circumferential surface 31a of the inlet portion 31. This restricts movement of the spacer 44 towards the intake air downstream side. As a result, the restriction of the arrangement position of the throttling portion 47 suppresses fluctuations in the efficiency for drawing the blow-by gas BG into the intake passage 13.

(9) The groove 36, which opens at the downstream end 35b of the drawing passage 35, is formed in the inner circumferential surface 31a of the inlet portion 31. Further, the open area of the groove 36 is larger than the open area of the downstream end 35b of the drawing passage 35. Thus, in comparison to when the blow-by gas BG is drawn into the intake passage 13 from the downstream end 35b of the drawing passage 35 without the groove 36, the area where the intake air SA flowing through the second passage 42 contacts the blow-by gas BG is increased. As a result, the blow-by gas BG can be efficiently drawn into the intake passage 13.

(10) The groove 36 is annular. The blow-by gas BG drawn from the drawing passage 35 into the groove 36 flows through the groove 36 and spreads over the entire inner circumference of the inlet portion 31. Thus, the blow-by gas BG is evenly drawn into the intake passage 13 from the entire circumference of the inlet portion 31 that forms part of the intake passage 13.

(11) Even when foreign matter that inhibits the flow of the blow-by gas BG is clogged in part of the groove 36, the blow-by gas BG flows through the portion that is not clogged by the foreign matter and is drawn into the intake passage 13. Thus, the blow-by gas BG drawn into the intake passage 13 is prevented from being inhibited by a deposit of the oil contained in the blow-by gas BG or the like.

The embodiment may be modified as described below.

In the embodiment, the inlet portion 31 may be formed so that the diameter of the outer circumference of the spacer 44 is less than or equal to the diameter L2 of the second inner circumferential part 31a2.

Instead of the structure including the projections 45 on the outer circumferential surface of the spacer 44, a support projecting outward in the radial direction may be arranged on the inner circumferential surface 31a of the inlet portion 31 to support the spacer 44. This structure can also form the second passage 42 that includes a zone between the inner circumferential surface 31a of the inlet portion 31 and the outer circumferential surface 44a of the spacer 44.

In the embodiment, the groove may have any shape other than an endless annular shape such as in the embodiment as long as the shape is larger than the open area of the downstream end 35b in the drawing passage 35. For instance, a groove may be formed to have an arcuate shape having a fixed length and extending along the inner circumferential surface 31a.

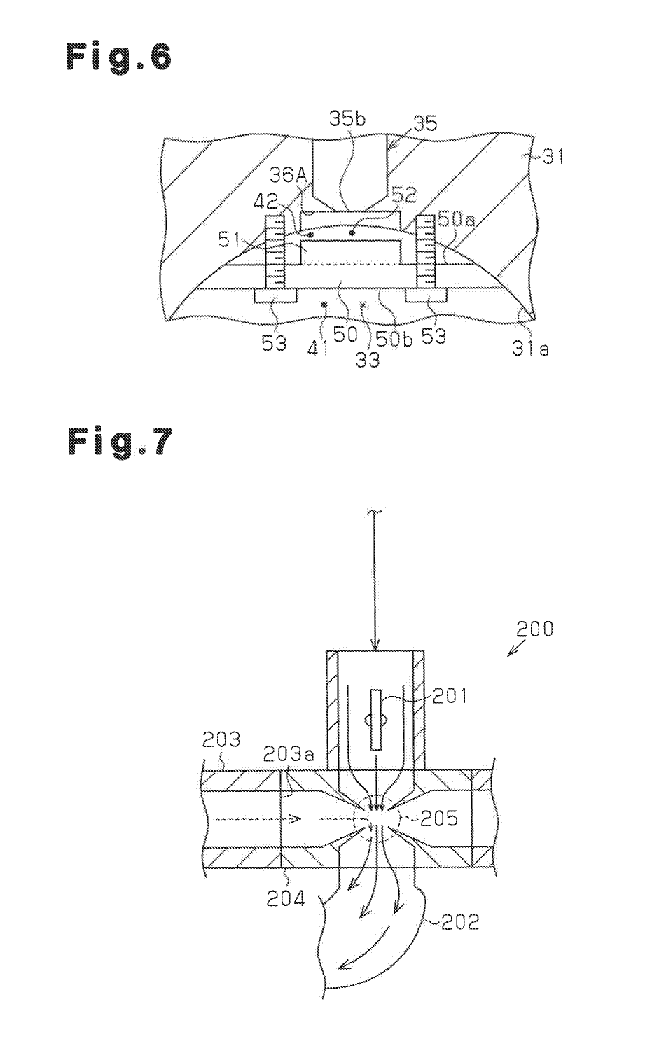

Further, as shown in FIG. 6, the inlet portion 31 may include a non-annular recess 36A. In this case, the recess 36A has a width (length in the sideward direction as viewed in FIG. 6) that is preferably larger than the width of the downstream end 35b in the drawing passage 35.

As shown in FIG. 6, if the recess 36A is formed in the inlet portion 31, a branching plate 50 may be arranged as the branching member in lieu of the spacer 44. In this case, the branching plate 50 is arranged so that the second passage 42 is formed between a first surface 50a and a formation portion of the recess 36A in the inner circumferential surface 31a, and the first passage 41 is formed between a second surface 50b located opposite to the first surface 50a and a portion that does not include the recess 36A in the inner circumferential surface 31a. A protrusion 51 may be arranged at a portion facing the recess 36A on the first surface 50a of the branching plate 50. Such a structure forms a throttling portion 52 at the joined portion of the downstream end 35b in the drawing passage 35 and the second passage 42.

To attach the branching plate 50 shown in FIG. 6 to the compressor housing 30, a plurality of (two in FIG. 2) screws 53 may be used.

The inlet portion 31 of the compressor housing 30 shown in FIG. 6 does not have to include the recess 36A. In this case, the blow-by gas BG that reaches the downstream end 35b of the drawing passage 35 is directly drawn into the second passage 42.

In the embodiment, the groove 36 does not have to be arranged in the inlet portion 31 of the compressor housing 30. In this case, a protrusion protruding outward in the radial direction may be arranged at the portion facing the downstream end 35b of the drawing passage 35 on the outer circumference of the spacer 44.

In the embodiment, the spacer 44 does not have to be arranged in the intake zone 33. In this case, preferably, the inlet portion 31 is formed so that a throttling portion is formed at the joined portion of the intake passage 13 and the downstream end 35b of the drawing passage 35. For instance, the compressor housing 30 may be formed so that the inner diameter of the inlet portion 31 gradually decreases from the intake air upstream side toward the joined portion and gradually increases from the joined portion toward the intake air downstream side.

In the embodiment, the supercharger may be driven using the rotation of the crankshaft of the internal combustion engine 11 instead of the exhaust air EG from the engine main body 12.

### DESCRIPTION OF THE REFERENCE NUMERALS

11: internal combustion engine
13: intake passage
20: supercharger
23: compressor impeller
26: returning pipe passage
30: compressor housing
31: inlet portion
31a: inner circumferential surface
31a1: first inner circumferential part
31a2: second inner circumferential part
35: drawing passage
35b: downstream end
36: groove
36A: recess
41: first passage
42: second passage
44: spacer
44a: outer circumferential surface
45: projection
46, 51: protrusion
47, 52: throttling portion
50: branching plate

1. A supercharger comprising:
an impeller;
a compressor housing including an inlet portion configured to form part of an intake passage of an internal combustion engine, wherein the inlet portion draws intake air toward the impeller;
a drawing passage that extends through the inlet portion and draws blow-by gas from outside the inlet portion to inside the inlet portion; and
a throttling portion arranged at a joined portion of the intake passage, which is formed inside the inlet portion, and the drawing passage, wherein the throttling portion has a cross-sectional passage area at the joined portion that is smaller than a cross-sectional passage area of a portion located at an intake air upstream side of the joined portion and a cross-sectional passage area of a portion located at an intake air downstream side of the joined portion.

2. The supercharger according to claim 1, further comprising a branching member arranged inside the inlet portion, wherein the branching member branches the intake passage into a first passage, which does not include the joined portion, and a second passage, which includes the joined portion, at the intake air upstream side of the joined portion, and the first passage and the second passage are joined at the intake air downstream side of the joined portion,
wherein the throttling portion is arranged in the second passage.

3. The supercharger according to claim 2, wherein
the branching member is an annular member including an outer circumferential surface facing an inner circumferential surface of the inlet portion, and
the second passage includes a zone between the outer circumferential surface of the branching member and the inner circumferential surface of the inlet portion.

4. The supercharger according to claim 2, wherein the branching member is formed so that a flow rate of the intake air flowing through the first passage is greater than a flow rate of the intake air flowing through the second passage.

5. The supercharger according to claim 2, wherein
the inlet portion has an inner circumferential surface including
a first inner circumferential part in which the drawing passage opens, and
a second inner circumferential part located at the intake air downstream side of the first inner circumferential part,
the first inner circumferential part has a larger diameter than the second inner circumferential part, and
the branching member is arranged in the intake passage at a portion surrounded by the first inner circumferential part.

6. The supercharge according to claim 1, wherein
the inlet portion has an inner circumferential surface including a recess that is in communication with a downstream end of the drawing passage, and
the recess has a larger open area than the downstream end of the drawing passage.

7. The supercharge according to claim 3, wherein
the inner circumferential surface of the inlet portion includes a groove that is in communication with the drawing passage and extends annularly along the inner circumferential surface, and
an annular protrusion facing the groove is arranged on the outer circumference of the branching member.

8. The supercharger according to claim 3, wherein
the inner circumferential surface of the inlet portion includes
a first inner circumferential part in which the drawing passage opens, and
a second inner circumferential part located at the intake air downstream side of the first inner circumferential part,
the first inner circumferential part has a larger diameter than the second inner circumferential part, and
the branching member has the same inner diameter as the second inner circumferential part and is arranged in the intake passage at a portion surrounded by the first inner circumferential part.
